(19) United States
(12) Patent Application Publication
(10) Pub. No.: US 2026/0155988 A1
(43) Pub. Date: Jun. 4, 2026

(54) METHOD AND DEVICE FOR INTEGRITY VERIFICATION OF PARAMETER DATA IN AUTOSAR-BASED VEHICLE SYSTEMS

(71) Applicants: Hyundai Motor Company, Seoul (KR); Kia Corporation, Seoul (KR)

(72) Inventor: Gyeong Bin KONG, Hwaseong-Si (KR)

(21) Appl. No.: 19/220,241

(22) Filed: May 28, 2025

(30) Foreign Application Priority Data
Dec. 4, 2024 (KR) 10-2024-0178210

(51) Int. Cl. H04L 9/32

(52) U.S. Cl. CPC H04L 9/3236

(57) ABSTRACT

A method and an apparatus for verifying integrity of parameter data of a vehicle is disclosed. The method may include generating a hash value of parameter data of the vehicle. The parameter data may be stored in a memory block of at least one memory of the vehicle. In association with the generation of the hash value, an address of the memory block may be declared as a pointer variable to reference a changed address of the parameter data. The method may further include storing, in a memory area of the at least one memory, the hash value of the parameter data, and outputting the stored hash value based on receiving, from a diagnostic device, a request for the hash value to check for tampering.

### CROSS REFERENCE TO RELATED APPLICATION

The present application claims priority to a Korean provisional application No. 10-2024-0178210, filed on Dec. 4, 2024, the entire contents of which are incorporated herein by reference for all purposes.

### TECHNICAL FIELD

The present disclosure relates to a method and device for a standardized software platform for vehicles, and more specifically to a method and device for verifying the integrity of parameter data in a standardized vehicle system.

### BACKGROUND

As more functions related to acceleration, braking, and safety of vehicles (also referred to as “moving objects”) become electronic, various controllers for controlling them are being installed in vehicles, and the complexity of the electronic control system of the vehicle is increasing. In particular, even for the same function, having different software structures across different vehicles can increase the cost of vehicle manufacturing. In order to alleviate this problem, a standardized software platform or architecture, such as AUTOSAR (AUTomotive Open System ARchitecture) may be adopted and installed in each controller to standardize and modularize the software structure.

However, data error forgery (e.g., spoofing) or falsification in complex systems may have a fatal impact on vehicle safety and performance. In order to prevent this and secure reliability, integrity verification of parameter data in the AUTOSAR-based vehicle system has become important.

Some data integrity verification method treats dynamic data (e.g., data whose address may be variable) as if it is in a static state and references each memory address where the data is stored without changing it. In this case, due to the characteristics of the AUTOSAR-based vehicle system, the settings of all related modules in the architecture, such as non-volatile memory (NvM), Flash Electrically Erasable Programmable Read-Only Memory Emulation (Fee or FEE), and Flash Driver (Fls), may always have to be modified together, which can be less effective and inefficient.

That is, the existing data integrity verification method manages the address of a block where each data in the memory area is stored so that the address remains static, which results in requiring that the setting values of all modules in each layer be modified together. Thus, any change in the setting values can result in the safety or security through data integrity verification being weakened, and negatively affecting the overall reliability of the vehicle system.

In addition, when using the integrity verification method, if a specific verification logic is added or changed for data integrity verification, the interfaces and settings of all modules affected by the logic must be consistently modified, making it difficult to check whether individual data points have changed, and unnecessary operations may increase, reducing efficiency.

Accordingly, when performing integrity verification of data stored in the memory in the AUTOSAR-based vehicle system, there is a need for an efficient data integrity verification method that checks for forgery or falsification.

The matters described in this Background section are only for the enhancement of understanding of the background of the disclosure, and should not be taken as acknowledgment that they correspond to prior art already known to those skilled in the art.

### SUMMARY

An object of the present disclosure is to provide a method and device for efficiently verifying the integrity of parameter data in a vehicle software platform, such as an AUTOSAR-based vehicle system.

Another object of the present disclosure is to provide a method and device for verifying the integrity of parameter data in a vehicle software platform, such as an AUTOSAR-based vehicle system that efficiently verifies whether it is forged or falsified by calculating a hash value of parameter data stored in a memory area.

Another object of the present disclosure is to provide a method and device for directly referencing a changed address of a memory area in which data to be verified is stored, without changing settings of a vehicle software platform, such as an AUTOSAR-based vehicle system, in order to solve the technical problems of the present disclosure.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

According to one or more example embodiments of the present disclosure, a method performed by an apparatus of a vehicle may include generating a hash value of parameter data of the vehicle. The parameter data may be stored in a memory block of at least one memory of the vehicle. In association with the generation of the hash value, an address of the memory block may be declared as a pointer variable to reference a changed address of the parameter data. The method may further include: storing, in a memory area of the at least one memory, the hash value of the parameter data; and outputting the stored hash value based on receiving, from a diagnostic device, a request for the hash value to check for tampering.

The memory block may include a flash electrically erasable programmable read-only memory emulation (Fee) block and a redundant block.

Generating the hash value of the parameter data may include: generating a first hash value of first parameter data stored in a flash electrically erasable programmable read-only memory emulation (Fee) block; generating a second hash value of a redundant block, in which the first parameter data, as stored in the Fee block, is stored redundantly; and generating a third hash value based on the first hash value and the second hash value.

The first parameter data may be stored in an address of the Fee block and include a parameter to be protected from tampering.

Generating the third hash value may include: sequentially calling a secure flash hash update function for each block of the Fee block and the redundant block.

Outputting the stored hash value may include returning a pending response until the generating of the hash value is completed.

The method may further include checking for tampering by: comparing the hash value of the parameter data with an existing hash value that was, after the parameter data was determined, pre-registered in a server; and determining, based on the hash value of the parameter data matching the existing hash value, that the parameter data has not been tampered with.

The method may further include checking for tampering by: comparing the hash value of the parameter data with an existing hash value that was, after the parameter data was determined, pre-registered in a server; and determining, based on the hash value of the parameter data not matching the existing hash value, that the parameter data has been tampered with.

Generating the hash value of the parameter data may include: calling, based on no more parameter remaining in the parameter data for generating a hash value, a function for completing hash generation.

Generating the hash value of the parameter data may further include: recording, based on a hash generation function generating a return value error, an integrity verification fail count; and returning, based on the integrity verification fail count exceeding a threshold value, a vehicle software platform of the vehicle to an initial state by starting new parameter data integrity verification.

According to one or more example embodiments of the present disclosure, a device for verifying integrity of parameter data of a vehicle may include: a processor; and a memory storing at least one instruction that is configured, when executed by the processor communicating with the memory, to cause the device to generate a hash value of parameter data of the vehicle. The parameter data may be stored in a memory block of at least one memory of the vehicle. In association with the generation of the hash value, an address of the memory block may be declared as a pointer variable to reference a changed address of the parameter data. The at least one instruction is configured, when executed by the processor communicating with the memory, to further cause the device to: store, in a memory area of the at least one memory, the hash value of the parameter data; and output the stored hash value based on receiving, from a diagnostic device, a request for the hash value to check for tampering.

The memory block may include a flash electrically erasable programmable read-only memory emulation (Fee) block and a redundant block.

The at least one instruction may be configured, when executed by the processor communicating the memory, to cause the device to generate the hash value of the parameter data by: generating a first hash value of first parameter data stored in a flash electrically erasable programmable read-only memory emulation (Fee) block; generating a second hash value of a redundant block, in which the first parameter data, as stored in the Fee block, is stored redundantly; and generating a third hash value based on the first hash value and the second hash value.

The first parameter data may be stored in an address of the Fee block and include a parameter to be protected from tampering.

The at least one instruction may be configured, when executed by the processor communicating the memory, to cause the device to generate the third hash value by: sequentially calling a secure flash hash update function for each block of the Fee block and the redundant block.

The at least one instruction may be configured, when executed by the processor communicating the memory, to cause the device to output the stored hash value by: returning a pending response until the generating of the hash value is completed.

The at least one instruction may be configured, when executed by the processor communicating the memory, to further cause the device to check for tampering by: comparing the hash value of the parameter data with an existing hash value that was, after the parameter data was determined, pre-registered in a server; and determining, based on the hash value of the parameter data matching the existing hash value, that the parameter data has not been tampered with.

The at least one instruction may be configured, when executed by the processor communicating the memory, to further cause the device to check for tampering by: comparing the hash value of the parameter data with an existing hash value that was, after the parameter data was determined, pre-registered in a server; and determining, based on the hash value of the parameter data not matching the existing hash value, that the parameter data has been tampered with.

The at least one instruction may be configured, when executed by the processor communicating the memory, to generate the hash value of the parameter data by: calling, based on no more parameter remaining in the parameter data for generating a hash value, a function for completing hash generation.

The at least one instruction may be configured, when executed by the processor communicating the memory, to generate the hash value of the parameter data further by: recording, based on a hash generation function generating a return value error, an integrity verification fail count; and returning, based on the integrity verification fail count exceeding a threshold value, a vehicle software platform of the vehicle to an initial state by starting new parameter data integrity verification.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram of an example architecture of a vehicle software platform in which parameter data is stored and managed;

FIG. 2 is a diagram showing one or more example interactions between a controller and a diagnostic device by performing integrity verification of parameter data;

FIG. 3 is a flowchart of an example method of verifying the integrity of parameter data in a vehicle system with a vehicle software platform;

FIG. 4 is a flowchart showing an example operation mechanism of a device for verifying the integrity of parameter data in a vehicle system with a vehicle software platform; and

FIG. 5 shows an example computing system.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

Hereinafter, AUTOSAR is a standardized open platform for automotive software architecture, created to enable automotive manufacturers, component suppliers, and others to efficiently develop and integrate electronic control units (ECUs) and software for vehicles. AUTOSAR includes software architecture, basic software modules (BSW), application software modules (ASW), runtime environment (RTE), service interfaces, and more. Additionally, the term “standardized” means that the function names, functionalities, return values, etc., are predefined. “Open” refers to the fact that it is available for use by anyone. However, throughout this disclosure, it is to be understood that AUTOSAR is only one example of a standardized open platform for automotive software architecture, and the present disclosure may be applicable to any standardized open platform or any non-standardized or proprietary automotive software architecture or to a software platform of any kind (e.g., a vehicle software platform).

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In the present disclosure, the “system” may include at least one device among a computing device, a network device, a controller, a vehicle device, a server device, and/or a cloud device, but is not limited thereto. For example, the system may include (or configured with) one or more server devices. As another example, the system may include (or configured with) one or more cloud devices. As another example, the system may operate by a server device and a cloud device.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

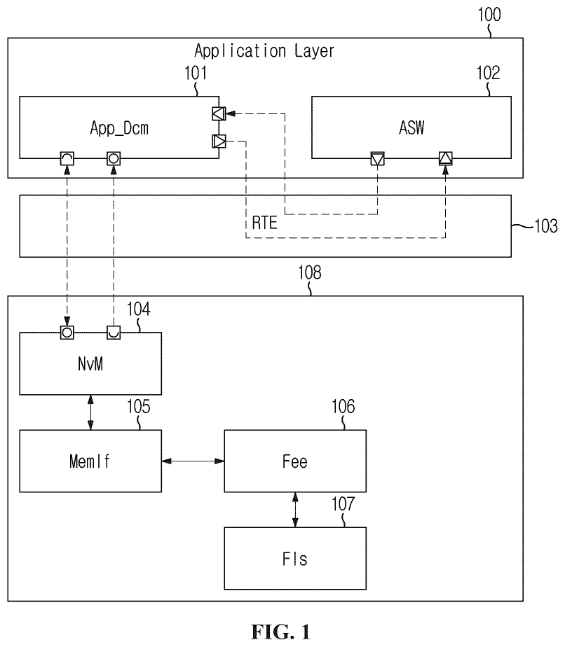

Hereinafter, the architecture of a module for storing and managing parameter data in an AUTOSAR-based vehicle system will be described with reference to FIG. 1.

FIG. 1 is a diagram of an example architecture of a vehicle software platform in which parameter data is stored and managed. The vehicle software platform may be, for example, an AUTOSAR platform.

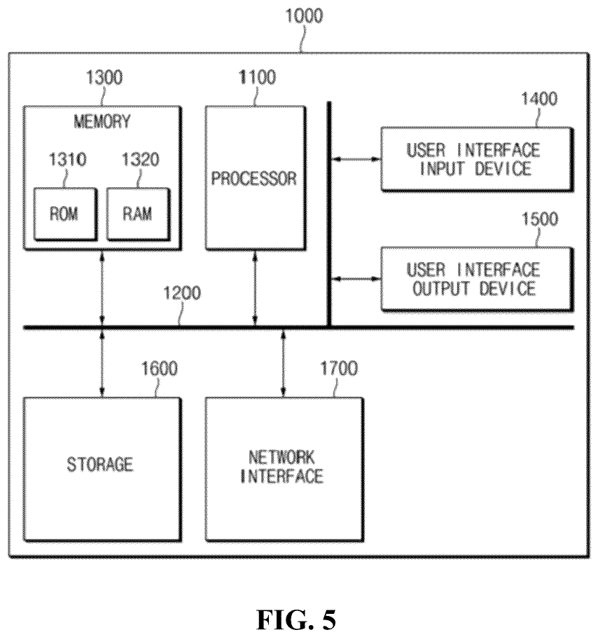

As shown in FIG. 1, the platform structure of AUTOSAR is a layered architecture structure in which layers are separated and hardware-independent software may be developed in a layered structure, and reusability and extensibility can be improved. This AUTOSAR platform layered architecture may include an application layer 100, a Runtime Software (RTE) layer 103, and a Basic Software (BSW) layer 108. The platform structure of AUTOSAR may be implemented in one or more computing devices (e.g., the example computing device shown in FIG. 5). For example, the platform structure of AUTOSAR (e.g., one or more software modules implementing the platform structure of AUTOSAR) may be stored in one or more storages and/or memories, and one or more program instructions (e.g., computer program code) may be executed by one or more processors of the one or more computing devices.

The application layer 100 is a layer where high-performance software modules that perform specific functions in the vehicle system are located. The modules of this layer may generally be composed of application software (ASW) 102 that is in charge of specific functions and a Diagnostic Communication Manger (App_Dcm) module 101. In addition, the application layer 100 may include a plurality of software components (SWCs), each of which includes a vehicle control logic.

In an example, the App_Dcm module 101 is a module that may process vehicle diagnosis-related data and may exchange vehicle diagnostic data and parameters by implementing a diagnostic communication protocol (e.g., UDS (Unified Diagnostic Services)). The App_Dcm module 101 may store and manage parameters using a non-volatile memory (NvM) 104 while performing a diagnostic function. The application software (ASW) 102 is a core module of the application layer 100 and is a component that may perform an algorithm for at least one function performed in a vehicle and may be responsible for the actual function of the vehicle. For example, it is responsible for various vehicle control and management functions such as engine control and battery management, and may communicate with the RTE layer to call a service of a lower layer. A software component (SWC) is an independent execution unit and may be divided into a motor control software component, a battery control software component, a mode control software component, and a user interface software component depending on the control target.

The RTE layer 103 is an intermediate layer that may manage communication between various software modules in the AUTOSAR. The RTE layer 103 may provide an abstraction layer between the application software module (ASW) and the hardware resources of the system, and may mediate data and service calls between the application software module 102 and the BSW layer 108. The RTE layer 103 may allow the application software to run independently without directly relying on lower-level modules such as NvM, Memlf, Fee, and Fls, and to call modules of the BSW layer 108 that provide various functions.

The BSW layer 108 may be responsible for interface with hardware and may provide common functions throughout the system. The BSW layer 108 may include various BSW modules for storing and managing parameter data. For example, the BSW modules may include a NvM (Non-Volatile Memory Manager) module 104, a Memlf (Memory Interface Layer Functions) module 105, a Fee (Flash EEPROM Emulation) module 106, and a Fls (Flash) module 107.

The NvM module 104 is a module that may be responsible for interacting with a nonvolatile memory. The NvM module 104 may store or read data requested by application software in or from the nonvolatile memory such as Electrically Erasable Programmable Read-Only Memory (EEPROM) or Flash. Here, the EEPROM is a nonvolatile memory whose data may be erased and rewritten, and may maintain stored data even when power is turned off. In other words, this allows parameter data to be maintained even after a system restart. The NvM module 104 may interact with a memory abstraction layer through the Memlf module 105, and may store or load actual data in the Fee module 106 or the Fls module 107.

The Memlf module 105 is a layer that may provide a consistent interface regardless of the type of the memory, abstracting a physical memory interface used by the NvM module, so that it may maintain compatibility with various memory devices. This may help modules such as NvM to be independent of specific hardware.

The Fee module 106 is a module that may emulate the functionality of the EEPROM in the Flash memory. The Fee module 106 may provide features similar to the EEPROM using the Flash memory, and may be used when the EEPROM is physically insufficient or when speed and cost efficiency are important. The Fls module 107 is a module that may be responsible for low-level control of the Flash memory. The Fls module 107 may read or write data from or in the Flash memory. Through the Fls module 107, the Fee module 106 and the NvM module 104 may permanently store data using the Flash memory. In other words, the Fls module 107 may directly read or write data from or in the memory, and the Fee module 106 may manage data to use the Flash memory like the EEPROM.

Therefore, the architecture of the AUTOSAR platform may allow the RTE to minimize dependencies between application software and sub-modules, and provides flexibility and scalability to the system, thereby efficiently handling the storage and management of parameter data.

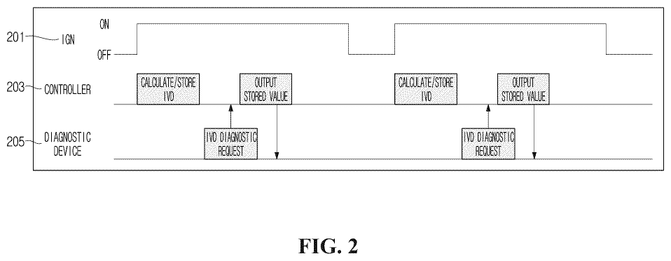

FIG. 2 is a diagram showing one or more example interactions between a controller and a diagnostic device by performing integrity verification of parameter data.

Referring to FIG. 2, the data movement flow during data integrity verification according to On/Off of an ignition (IGN) 201 may be described.

Here, the controller 203 may be a device that controls various functions within the vehicle. For example, various systems such as engine control, brake system control, and driving control may be operated by the controller 203. In the AUTOSAR-based vehicle system, parameters may be set within each controller 203, and integrity verification of the parameters may be performed by the controller 203. The diagnostic device 205 may be a device that diagnoses and inspects the vehicle status outside the vehicle. The diagnostic device 205 may read logs or diagnostic information regarding errors or abnormal data transmitted from the controller 203. In the AUTOSAR-based vehicle system, the diagnostic device 205 need not directly perform integrity verification, but may request verified data, receive the output result value, and interpret it. Each of the controller 203 and the diagnostic device 205 may be implemented with software, hardware (e.g., a processor, memory, a communication interface, input/output device, etc.), or a combination of both.

That is, the process of verifying the integrity of parameter data in the AUTOSAR-based vehicle system may be performed by the controller 203 of the vehicle, and the integrity verification result may be output by the diagnostic device 205. The data verification and output process between the controller 203 and the diagnostic device 205 may be predicted depending on the On/Off of the IGN 201.

The layers and modules included in each layer mentioned above in FIG. 1 may exist within the controller 203. The controller 203 may be composed of software architecture and hardware, and the software architecture within the controller is divided into several layers, and each layer may perform a specific role when performing integrity verification of parameter data.

Specifically, the controller 203 may process various parameters based on data collected through various sensors or actuators of the vehicle. At this time, integrity verification data (IVD) may be used to verify the integrity of the parameter data. First, the controller 203 may receive the values of important parameter data of the vehicle from sensors or other ECUs. Here, the important parameter data (also referred to as critical parameter data or protected parameter data) refers to data related to parameters that may be targeted for and is to be protected from tampering (e.g., forgery or falsification) of data, and may be parameters related to regulations, such as a maximum vehicle speed, a vehicle manufacturer number, an odometer reading, etc. The controller 203 may calculate IVD to verify the integrity of the values of the parameter data, and the IVD may generally be calculated by hashing the data or through an algorithm, such as cyclic redundancy check (CRC). For example, the controller 203 may process the parameter data and generate IVD based on the data.

The controller 203 may perform integrity verification to determine whether the parameter data has been falsified, altered, tampered with, or damaged by calculating an IVD value and comparing it with IVD already registered in a server, etc.

Specifically, the data integrity verification process of the vehicle system may first compare the IVD value calculated by the controller 203 with the existing IVD value to check whether the data has been forged or falsified. If the IVD value calculated by the controller matches the existing IVD value, the parameter data may be determined to have maintained its integrity. On the other hand, if the values do not match or an error occurs, it may be determined that there is a problem with the data integrity, and the data may be corrected or the vehicle status may be diagnosed.

The IVD value calculated by the controller may be calculated periodically and may be newly calculated for each IG cycle (e.g., a periodic cycle while the vehicle is running). At this time, the calculated IVD value may be stored in random access memory (RAM), which is a volatile memory, and may be output when a diagnostic request is made after being stored.

The diagnostic device 205 of the vehicle may check the status of the controller 203 and send a diagnostic request to verify the integrity verification result of parameter data. The diagnostic device 205 may, for example, be connected via an On-Board Diagnostics (OBD) port of the vehicle or another diagnostic interface. The diagnostic device 205 may send an IVD ReadData service request through communication with the controller 203 of the vehicle in the IGN On state. The integrity verification result of the parameter data performed by the controller 203 may be provided by this request. In other words, the IVD result calculated by the controller 203 is requested to be output to the diagnostic device 205. However, in the IVD ReadData service, the controller may transmit a response in a pending state if the controller is performing IVD calculation. The pending response may mean that the calculation is not yet completed and is being processed. Accordingly, the diagnostic device may be switched to a waiting state so that the controller may request data again after the calculation is completed.

The operations of the controller 203 and the diagnostic device 205 may differ depending on the On/Off of the IGN 201. If the IGN 201 is in the On state, the controller 203 may operate and process parameter data to respond to the diagnostic request through calculation of the IVD. In other words, when the IGN 201 is in the On state, the controller 203 may be activated and may perform all operations related to data. On the other hand, if the IGN 201 is in the Off state, the controller 203 may not be operational or may only process some data in a limited state. In this case, operations related to the IVD may be limited, and even if the diagnostic device 205 requests data, the controller 203 may not be able to respond.

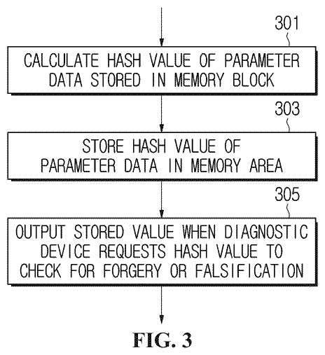

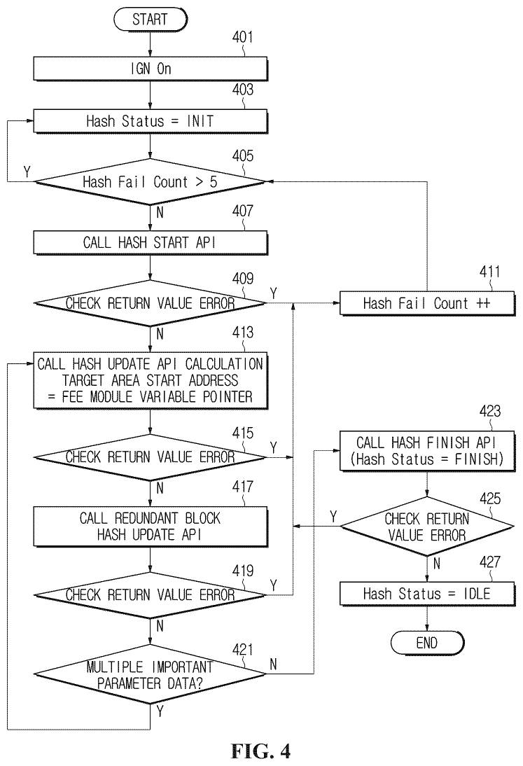

FIG. 3 is a flowchart showing an operation mechanism of an example device for verifying the integrity of parameter data in a vehicle system with a vehicle software platform. One, some, or all steps of the example methods of FIGS. 3 and 4, or portions thereof, may be performed by one or more other circuits. One or some, steps of the example method of FIGS. 3 and 4 may be omitted, performed in other orders, and/or otherwise modified, and/or one or more additional steps may be added.

Referring to FIG. 3, a parameter data integrity verification method according to the present disclosure may include calculating a hash value of parameter data stored in a memory block (301), storing the hash value of the parameter data in a memory area (303), and outputting the stored value when a diagnostic device requests the hash value to check for tampering (e.g., forgery, falsification, etc.) of data (305).

The calculating of the hash value of the parameter data stored in the memory block according to step 301 may be performed by the controller. After the controller receives a signal indicating that the IGN is turned on, the controller may calculate the hash value for the memory area including the parameter data (e.g., the important parameter data) stored in the EEPROM. Here, the important parameter data may refer to parameter data that may be targeted for and is to be protected from tampering (e.g., forgery or falsification) as described above. The important parameter data may include, for example, parameters related to regulations, such as the maximum vehicle speed, the vehicle manufacturer number, the odometer reading, etc.

In order for the controller to calculate the hash value of the memory area including important parameter data stored in the EEPROM, a Data Flash (dFlash) area may be referenced and a Fee module variable pointer may be used. Specifically, data stored in the dFlash area managed by the NvM module may include important parameter data. The controller may directly reference the address value of this memory area through the Fee module variable pointer. The Fee module variable pointer may specify the exact location of the memory, thereby reading required data by. Accordingly, the exact memory address where the important parameter data to be calculated is located may be identified, and the controller may calculate the hash of the corresponding area.

The SecureFlash_HashUpdate function (also referred to as a secure flash hash update function) may be called for each Fee block, which is a memory block where parameter data is stored, to update the hash value of the block. In this process, the data of each block may be processed one by one, and the hash value calculated in the previous block may be included in the hash calculation of the next block.

The SecureFlash_HashUpdate function may be sequentially called to generate (e.g., calculate) the hash value of a block related to the parameter data to be calculated, including a redundant block. At this time, the hash value of each block is accumulated based on the value calculated in the previous block, so that one hash value for final entire parameter data may be derived. The detailed process will be described in FIG. 4 below. Here, the redundant block is an area used for data backup, and is a memory area that may store the same data as the Fee block so that original data stored in the Fee block may be recovered when being damaged.

The storing of the hash value of the parameter data in the memory area according to step 303 may be performed by the controller similarly to step 301.

The IVD value is data that shall maintain the same value continuously since vehicle development, and the vehicle controller or system shall prevent unnecessary loading of previously generated (e.g., calculated) values for each cycle. In other words, the IVD value is a result calculated after the parameter input value is fixed, and since this value does not change, the result may not be recalculated each time or stored in a nonvolatile memory area.

Accordingly, the calculated IVD value may be stored on the server, etc., and this value may be a fixed IVD value calculated after the parameter data input value is fixed. The diagnostic device may request the hash value to check for tampering (e.g., forgery, falsification, etc.) of data and compare the newly calculated IVD value with the existing value registered in the server, etc. The comparison may be a process of checking whether the actual calculated value and the fixed value registered in the server are the same.

Here, the reason for storing the hash value of the parameter data in the memory area may be to efficiently verify the integrity of the calculated IVD value. Rather than directly storing the IVD value in the memory, the controller may store the hash value of the IVD value. By storing the hash value, the efficiency in terms of memory usage can be improved, and the hash value may enable rapid integrity verification when compared with the calculated IVD value.

Outputting of the stored value when the diagnostic device requests the hash value to check for tampering (e.g., forgery or falsification) of data according to step 305 above may be performed by the controller outputting it in response (e.g., after) to the diagnostic device's request for the currently calculated hash value for data integrity verification.

The diagnostic device requesting specific data from the controller may be a common diagnostic procedure in a vehicle system. For parameter data integrity verification, the diagnostic device may request the hash value of the IVD value from the controller, and the controller may receive the request of the diagnostic device and process the output.

Specifically, the internal processing of the controller according to the request of the diagnostic device has a pointer to the memory block storing parameter data, through which the exact location in the memory may be referenced. The controller may generate (e.g., calculate) the hash value and then transmit it to the diagnostic device through a communication protocol. The diagnostic device may check whether the data has been forged or falsified by comparing the calculated hash value transmitted from the controller with the value registered in the server, etc. If the two values match, it may be determined that the data has not been forged or falsified, and if they do not match, it may be determined that the data has been forged or falsified.

FIG. 4 is a flowchart showing an example operation mechanism of a device for verifying the integrity of important parameter data in a vehicle system with a vehicle software platform.

Referring to FIG. 4, by using the Fee module variable pointer, the parameter data integrity verification method according to the present disclosure may perform integrity verification by calculating only the hash value of the required area by referencing the address that is changed, without needing to change the setting of the AUTOSAR module. In addition, like other NvM blocks, by allowing the redundant block to be used without change, the reliability of the data can be increased and the possibility of system recovery can be secured.

Referring to FIG. 4, the process of verifying the integrity of important parameter data in the AUTOSAR-based vehicle system will be described as follows. If the IGN is turned on (401), a Hash Status variable may be set to INIT (403) to set the initial state for starting data integrity verification. That is, starting from the initial state, the hash value calculation may be prepared and the occurrence of an error may be tracked.

A Hash Fail Count status variable may be set to a reference count as a preset value (405), and if the reference count is exceeded, it may indicate the hash value calculation has failed. In this case, the hash value calculation may no longer be performed, and the method may return to step 403 and set the Hash Status variable to INIT to perform initialization. On the other hand, if the reference count is not exceeded, the Hash Start application programming interface (API) may be called. The value set to Hash Fail Count >5 in step 405 is an exemplary value, and a threshold value (e.g., reference count) other than 5 may be used. It is a value when it is assumed that there are 4 parameter data to be calculated, and the value may be changed. The reliability of the system may be maintained according to step 405, and the hash value calculation may be no longer repeated when there are too many errors.

That is, if the Hash Fail Count is less than or equal to the reference count, the Hash Start API may be called to start the hash value calculation (407). The Hash Start API may be a function that starts the hash value calculation. When this function is called, initialization operation for the hash value calculation may be performed and the status may be changed based on this. For example, the Hash Status may be changed to an “in progress” status (e.g., In_Progress).

A return value by step 407 may be checked by a Return Value Error function to determine whether there is an error (409). If it is determined that an error has occurred in the return value by the Return Value Error function, the Hash Fail Count status variable value in step 405 may be increased by the Hash Fail Count++ operation (also referred to as the hash fail count increment operation) (411). That is, it may be a process for stopping hash calculation and performing additional processing when an error occurs more than a certain count as a method of tracking repetitive error occurrence. On the other hand, if it is determined that no error has occurred in the return value, the hash value calculation may be continued.

If an error has not occurred, the Hash Update API function may be called to calculate and update the hash value (413). This function may continuously calculate and update the hash value to continuously check whether the data is maintained correctly. At this time, a calculation target area may be set by setting the start address of the data whose hash value should be calculated, so that the data may be managed in a nonvolatile memory and the address of the data may be tracked through the variable pointer of the Fee module. Specifically, when the Fee module variable pointer is used, the operation of the Fee module may be changed without changing the setting of the AUTOSAR module. If the Fee module references a variable in the existing setting in a pointer manner, the variable or memory area may be easily modified or expanded without additional module changes.

In addition, by using the Fee module variable pointer, the address where the data to be calculated is stored may be referenced as it is even if it changes. It may be implemented by referencing the address of the existing variable as it is without having to change the settings, and the operation may be adjusted only by changing the address of the variable or the memory management method. Accordingly, only the hash value of the required area may be calculated. In general, in order to verify the integrity of nonvolatile memory, the hash value shall be calculated for the entire data, but efficiency can be greatly enhanced by calculating the hash value only for the data area that has changed. In other words, by utilizing the variable pointer, the hash value may be calculated and verified only for the memory area that has actually changed. In addition, the hash value calculation for unnecessary data may be omitted.

The Return Value Error function may be called again to check whether there is an error in the value returned by the Hash Update API function call in step 413 (415). Even in this case, as in step 409, if there is an error in the return value, the Fail Count status variable value may be increased by the Hash Fail Count++ operation in step 411 (411). On the other hand, if there is no error in the return value, the hash value calculation may continue.

If there is no error in the return value by the Hash Update API function, the Redundant Block Hash Update API function may be called to update the hash value of the parameter data to be calculated for the Redundant block (417). As described above, the Redundant block may duplicate and store the same data as the data stored in the Fee block at two or more physical locations in order to increase the reliability of the data. In the existing AUTOSAR system, separate logic was added to implement the Redundant block, and since memory management was fixed, data was stored redundantly in multiple blocks, making it difficult to use in system design. In one or more aspects of the present disclosure, the Redundant Block may be used in the same way as other NvM blocks by using the Fee module variable pointer. Specifically, the memory address may be dynamically allocated and referenced by using the Fee module variable pointer. In other words, by using the Fee module variable pointer, the Fee module may flexibly reference and manage the memory address by being compatible with the existing NvM management method, so that the duplicate data stored in the Redundant block and the reconstruction operation may be processed together with other NvM blocks.

The Return Value Error function may be called again to check whether there is an error in the value returned by the Redundant Block Hash Update API function call in step 417 (419). In this case, as in step 409, if there is an error in the return value, the Hash Fail Count status variable value may be increased by the Hash Fail Count++ operation in step 411 (411). On the other hand, if there is no error in the return value, the hash value calculation may continue.

If it is determined that there is no error in the return value, it may be possible to check whether there are multiple important parameter data (421). If there are multiple items in the parameter data, the hash value may be calculated individually for each parameter, and repeated hash value updates may be performed to finally calculate a single integrated hash value. That is, the system may first check whether there are multiple important parameter data. For example, if the parameter data is managed as an array or a list, the length of the list may be checked to determine whether there are multiple parameters to be calculated. Accordingly, if there are multiple important parameter data, the hash value may be generated (e.g., calculated) individually for each parameter and updated, and if calculation is required, the Hash Update API may be called in step 413 to update the hash value of each parameter data. If there are not multiple important parameters, the Hash Finish API function may be called to end the hash value calculation (423). That is, the Hash Update API function of step 413 may update the hash value by adding the corresponding parameter data to the existing hash value whenever a new parameter is added. By updating the hash value for each parameter, a final hash value may be calculated that ultimately contains the hash values of all parameter data.

The Return Value Error function may be called again to check the return value by calling the Hash Finish API function in step 423 to determine whether an error has occurred (425). As in step 409, if there is an error in the return value, the Hash Fail Count status variable value may be increased by the Hash Fail Count++operation in step 411 (411). On the other hand, if there is no error in the return value, it may indicate that the hash value calculation was completed normally (e.g., without an error), and subsequent processing may be performed.

If it is determined that there is no error in the return value, the hash value calculation is terminated and the Hash Status variable, which tracks the current state of the system, may be changed to an IDLE state (427). The IDLE state may indicate that the hash value calculation is no longer in progress, and the hash value is calculated only once during the IG cycle and may be in a standby state thereafter. In other words, when the system switches to the IDLE state, this state may indicate that the important parameter data integrity verification is completed.

FIG. 5 shows an example computing system (e.g., a computing device of a vehicle or any other apparatuses/devices). One or more controllers, processors, etc. described herein may be implemented by the computing system or may be implemented in the computing system.

Referring to FIG. 5, a computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

While the methods of the present disclosure described above are represented as a series of operations for clarity of description, it is not intended to limit the order in which the steps are performed. The steps described above may be performed simultaneously or in different order, as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

According to the present disclosure, a method is provided for verifying integrity of parameter data in an AUTOSAR-based vehicle system. The method may comprise calculating a hash value of parameter data stored in a memory block, storing the hash value of the parameter data in a memory area and outputting the stored value when a diagnostic device requests a hash value to check for forgery or falsification, wherein when the hash value of the parameter data stored in the memory block is calculated, an address of the memory block is declared as a pointer variable to reference a changed address at it is.

According to an example of the method of the present disclosure, the method of claim 1, wherein the memory block includes both a Fee block and a Redundant block.

According to an example of the method of the present disclosure, the method of claim 1, wherein the calculating the hash value of the parameter data comprises calculating a hash value of parameter data stored in a Fee block, calculating a hash value of a Redundant block in which the same parameter data as the parameter data stored in the Fee block is stored redundantly and calculating one hash value by adding the hash value of the Fee block and the hash value of the Redundant block.

According to an example of the method of the present disclosure, the method of claim 3, wherein the parameter calculated and stored in an address of the Fee block is a parameter to be forged or falsified.

According to an example of the method of the present disclosure, the method of claim 3, wherein the calculating one hash value by adding the hash value of the Fee block and the hash value of the Redundant block comprises using a SecureFlash_HashUpdate function, and calculating one hash value including all blocks by sequentially calling the SecureFlash_HashUpdate function for each block.

According to an example of the method of the present disclosure, the method of claim 1, wherein the outputting the hash value of the parameter data according to the request for integrity verification comprises returning a pending response until calculation is completed when the hash value of the parameter is being calculated.

According to an example of the method of the present disclosure, the method of claim 1, further comprising checking for falsification by comparing the hash value of the parameter data with an existing hash value pre-registered in a server after fixing parameter data, wherein when the hash value of the parameter data matches the existing hash value, it is determined that the parameter data has not been forged or falsified.

According to an example of the method of the present disclosure, the method of claim 7, wherein when the hash value of the parameter data does not match the existing hash value, it is determined that the parameter data has been forged or falsified.

According to an example of the method of the present disclosure, the method of claim 1, wherein in the calculating the hash value of the parameter data stored in the memory block, when there is no more parameter data whose hash value is calculated, a function for completing hash calculation is called and a hash value calculated so far is finally generated and stored.

According to an example of the method of the present disclosure, the method of claim 9, wherein when an error occurs by checking a Return Value Error of a hash calculation function, an integrity verification fail count is recorded, and when the integrity verification fail count exceeds a predetermined count, it is returned to an initial state to start new parameter data integrity verification.

According to another example of the present disclosure, a device is provided verifying integrity of parameter data in an AUTOSAR-based vehicle system. The device may comprising a memory configured to store at least one instruction and store a hash value of parameter data for each memory block and a processor configured to execute the at least one instruction stored in the memory the processor is configured to calculate a hash value of parameter data stored in a memory block, store the hash value of the parameter data in a memory area and output the stored value when a diagnostic device requests a hash value to check for forgery or falsification, wherein when the hash value of the parameter data stored in the memory block is calculated, an address of the memory block is declared as a pointer variable to reference a changed address at it is.

According to an example of the device of the present disclosure, the device of claim 11, wherein the memory block includes both a Fee block and a Redundant block.

According to an example of the device of the present disclosure, the device of claim 11, wherein in order to calculate the hash value of the parameter data, the processor is configured to calculate a hash value of parameter data stored in a Fee block, calculate a hash value of a Redundant block in which the same parameter data as the parameter data stored in the Fee block is stored redundantly and calculate one hash value by adding the hash value of the Fee block and the hash value of the Redundant block.

According to an example of the device of the present disclosure, the device of claim 11, wherein in the processor, the parameter calculated and stored in an address of the Fee block is a parameter to be forged or falsified.

According to an example of the device of the present disclosure, the device of claim 11, wherein the processor is configured to when calculating one hash value by adding the hash value of the Fee block and the hash value of the Redundant block, use a SecureFlash_HashUpdate function, and calculate one hash value including all blocks by sequentially calling the SecureFlash_HashUpdate function for each block.

According to an example of the device of the present disclosure, the device of claim 11, wherein the processor is configured to when outputting the hash value of the parameter data according to the request for integrity verification, return a pending response until calculation is completed when the hash value of the parameter is being calculated.

According to an example of the device of the present disclosure, the device of claim 11, wherein the processor is configured to check for falsification by comparing the hash value of the parameter data with an existing hash value pre-registered in a server after fixing parameter data, determine that the parameter data has not been forged or falsified when the hash value of the parameter data matches the existing hash value.

According to an example of the device of the present disclosure, the device of claim 17, wherein the processor is configured to determine that the parameter data has been forged or falsified when the hash value of the parameter data does not match the existing hash value.

According to an example of the device of the present disclosure, the device of claim 11, wherein the processor is configured to if the hash value of the parameter data stored in the memory block is calculated, call a function for completing hash calculation and finally generate and store a hash value calculated so far when there is no more parameter data whose hash value is calculated.

According to an example of the device of the present disclosure, the device of claim 11, wherein the processor is configured to when an error occurs by checking a Return Value Error of a hash calculation function, record an integrity verification fail count, and return to an initial state to start new parameter data integrity verification when the integrity verification fail count exceeds a predetermined count.

The effects obtainable from the present disclosure are not limited to the above-mentioned effects, and other effects not mentioned herein will be clearly understood by those skilled in the art through the following descriptions.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus of a vehicle, the method comprising:
generating a hash value of parameter data of the vehicle, wherein the parameter data is stored in a memory block of at least one memory of the vehicle, and wherein, in association with the generation of the hash value, an address of the memory block is declared as a pointer variable to reference a changed address of the parameter data;
storing, in a memory area of the at least one memory, the hash value of the parameter data; and
outputting the stored hash value based on receiving, from a diagnostic device, a request for the hash value to check for tampering.

2. The method of claim 1, wherein the memory block comprises a flash electrically erasable programmable read-only memory emulation (Fee) block and a redundant block.

3. The method of claim 1, wherein the generating of the hash value of the parameter data comprises:
generating a first hash value of first parameter data stored in a flash electrically erasable programmable read-only memory emulation (Fee) block;
generating a second hash value of a redundant block, in which the first parameter data, as stored in the Fee block, is stored redundantly; and
generating a third hash value based on the first hash value and the second hash value.

4. The method of claim 3, wherein the first parameter data is stored in an address of the Fee block and comprises a parameter to be protected from tampering.

5. The method of claim 3, wherein the generating of the third hash value comprises:
sequentially calling a secure flash hash update function for each block of the Fee block and the redundant block.

6. The method of claim 1, wherein the outputting of the stored hash value comprises returning a pending response until the generating of the hash value is completed.

7. The method of claim 1, further comprising checking for tampering by:
comparing the hash value of the parameter data with an existing hash value that was, after the parameter data was determined, pre-registered in a server; and
determining, based on the hash value of the parameter data matching the existing hash value, that the parameter data has not been tampered with.

8. The method of claim 1, further comprising checking for tampering by:
comparing the hash value of the parameter data with an existing hash value that was, after the parameter data was determined, pre-registered in a server; and
determining, based on the hash value of the parameter data not matching the existing hash value, that the parameter data has been tampered with.

9. The method of claim 1, wherein the generating of the hash value of the parameter data comprises:
calling, based on no more parameter remaining in the parameter data for generating a hash value, a function for completing hash generation.

10. The method of claim 9, wherein the generating of the hash value of the parameter data further comprises:
recording, based on a hash generation function generating a return value error, an integrity verification fail count; and
returning, based on the integrity verification fail count exceeding a threshold value, a vehicle software platform of the vehicle to an initial state by starting new parameter data integrity verification.

11. A device for verifying integrity of parameter data of a vehicle, the device comprising:
a processor; and
a memory storing at least one instruction that is configured, when executed by the processor communicating with the memory, to cause the device to:
generate a hash value of parameter data of the vehicle, wherein the parameter data is stored in a memory block of at least one memory of the vehicle, and wherein, in association with the generation of the hash value, an address of the memory block is declared as a pointer variable to reference a changed address of the parameter data;
store, in a memory area of the at least one memory, the hash value of the parameter data; and
output the stored hash value based on receiving, from a diagnostic device, a request for the hash value to check for tampering.

12. The device of claim 11, wherein the memory block comprises a flash electrically erasable programmable read-only memory emulation (Fee) block and a redundant block.

13. The device of claim 11, wherein the at least one instruction is configured, when executed by the processor communicating the memory, to cause the device to generate the hash value of the parameter data by:
generating a first hash value of first parameter data stored in a flash electrically erasable programmable read-only memory emulation (Fee) block;
generating a second hash value of a redundant block, in which the first parameter data, as stored in the Fee block, is stored redundantly; and
generating a third hash value based on the first hash value and the second hash value.

14. The device of claim 13, wherein the first parameter data is stored in an address of the Fee block and comprises a parameter to be protected from tampering.

15. The device of claim 13, wherein the at least one instruction is configured, when executed by the processor communicating the memory, to cause the device to generate the third hash value by:
sequentially calling a secure flash hash update function for each block of the Fee block and the redundant block.

16. The device of claim 11, wherein the at least one instruction is configured, when executed by the processor communicating the memory, to cause the device to output the stored hash value by:
returning a pending response until the generating of the hash value is completed.

17. The device of claim 11, wherein the at least one instruction is configured, when executed by the processor communicating the memory, to further cause the device to check for tampering by:
comparing the hash value of the parameter data with an existing hash value that was, after the parameter data was determined, pre-registered in a server; and
determining, based on the hash value of the parameter data matching the existing hash value, that the parameter data has not been tampered with.

18. The device of claim 11, wherein the at least one instruction is configured, when executed by the processor communicating the memory, to further cause the device to check for tampering by:
comparing the hash value of the parameter data with an existing hash value that was, after the parameter data was determined, pre-registered in a server; and
determining, based on the hash value of the parameter data not matching the existing hash value, that the parameter data has been tampered with.

19. The device of claim 11, wherein the at least one instruction is configured, when executed by the processor communicating the memory, to generate the hash value of the parameter data by:
calling, based on no more parameter remaining in the parameter data for generating a hash value, a function for completing hash generation.

20. The device of claim 19, wherein the at least one instruction is configured, when executed by the processor communicating the memory, to generate the hash value of the parameter data further by:
recording, based on a hash generation function generating a return value error, an integrity verification fail count; and
returning, based on the integrity verification fail count exceeding a threshold value, a vehicle software platform of the vehicle to an initial state by starting new parameter data integrity verification.
